(19) United States
(12) Patent Application Publication
(10) Pub. No.: US 2025/0176601 A1
(43) Pub. Date: Jun. 5, 2025

(54) CORN STARCH FROM HYBRID CORN PLANT AND USE OF THE STARCH AS A TEXTURING AGENT

(71) Applicant: CORN PRODUCTS DEVELOPMENT, INC., WESTCHESTER, IL (US)

(72) Inventors: Katelyn MEYLER, Bridgewater, NJ (US); Leslie DREW, Bridgewater, NJ (US); Indumathi Kangampalayam PALANISWAMY, Bridgewater, NJ (US); Roxanna SHARIFF, Bridgewater, NJ (US); Katie FOX, Bridgewater, NJ (US); Douglas HANCHETT, Bridgewater, NJ (US)

(21) Appl. No.: 18/843,795

(22) PCT Filed: Mar. 8, 2023
(86) PCT No.: PCT/US2023/063900

§ 371 Date: Sep. 4, 2024

Related U.S. Application Data
(60) Provisional application No. 63/319,967, filed on Mar. 15, 2022.

(51) Int. Cl. A23L 29/212; A23C 9/137; A23C 11/10; C08B 31/00

(52) U.S. Cl. CPC A23L 29/212; A23C 9/137; A23C 11/103; C08B 31/00

(57) ABSTRACT

The technology disclosed in this specification is directed to starch from a hybrid corn plant. The starch is called in this specification an aewx corn starch or is described by the amylopectin fine structure of the starch. The starch had differentiated functionality compared to common waxy corn starch. Also disclosed in this specification are uses of unmodified aewx corn as a texturizer in, alone or in combination with a second ingredient in food composition.

This specification describes a specialty corn starch obtained from hybrid corn plant. The starch has different rheological properties than other starch and can be used to provide differentiated textures to and food compositions.

More specifically, this specification discloses corn starch obtained from a corn endosperm having three copies (also called doses) of the recessive waxy gene (wx) and two copies of the recessive amylose extender gene (ae). In this specification the specialty starch is called referred to in this specification as an aewx corn starch or is defined by physical characteristics that distinguish it from other starch. Increased dosage of the wx gene suppresses amylose formation. Being fully recessive for the wx gene the aewx corn starch is a type of waxy corn starch, meaning little to no amylose forms in the corn endosperm. Increased dosage of the ae gene (at least in a waxy starch) suppresses branch points in amylopectin resulting in amylopectin having generally increased side chain length. The specific genetic composition of the claimed aewx corn starch was selected for optimal functionality in the unmodified form. The corn starch is available from Ingredion Incorporated.

### BRIEF DESCRIPTION OF THE FIGURES

FIG. 1 provides photographs light microscopy 400× cooked unmodified waxy corn starch and cooked unmodified aewx corn starch.

FIG. 2 is a graph of the shear viscosity at 10 1/s obtained from a parallel plate rheometer of yogurts made with various gelling agents and various amounts of unmodified aewx corn starch.

FIG. 3 is a graph of various sensory attributes comparing yogurts made with various gelling agents.

The technology disclosed in this specification pertains to unmodified aewx corn starch (gelatinized or not), and its use as a texturizer to provide differentiated texture to food compositions. The differentiated textures derive at least in part from the unmodified aewx corn starch's amylopectin structure, which affects the rheology unmodified aewx corn starch in aqueous systems. This specification shows that a unmodified aewx corn starch dispersed in water retrogrades to form firmer compositions than a similar dispersions using waxy corn starch. In any embodiment described in this specification, a dispersion of unmodified aewx corn starch has a % retrogradation from about 45% to about 50%, or from about 46% to about 50% or from about 46% to about 49% when measured using the retrogradation test set forth in this specification.

The increased tendency to retrograde and other distinct textures and functions obtainable using the unmodified aewx corn starch are in part attributable to the fine structure of the starch. Being a type of waxy corn starch, the unmodified aewx corn starch described in this specification has little to no amylose. Instead, the starch is essentially only the branched polysaccharide amylopectin. Compared to waxy corn starch, the unmodified aewx corn starch described in this specification has on average longer branches. This can be seen in the collective average chain length (measured by degree of polymerization) of all branch chains and by having more longer chain length chains than shorter chain length chains. In any embodiment of an unmodified aewx corn starch described in this specification has an amylopectin fraction wherein a percent fraction of glycoside chains has a degree of polymerization (“DP”) between 25 and 36 of from about 17% to about 22%, or from about 18% to about 20%. In any embodiment described in this specification, an unmodified aewx corn starch has an amylopectin fraction wherein the starch has a percent fraction of glycoside chains having DP greater than 37 of from about 14% to about 18% or from about 15% to about 17%. In any embodiment described in this specification the unmodified aewx corn starch has an amylopectin fraction that comprises a distribution of glycoside chains having an average DP from about 23 to about 26, or from about 23 to about 25.

Unmodified aewx corn starch may be used in compositions in native form (ungelatinized) or be used in pregelatinized form. As shown in this specification, unmodified aewx corn starch provides differentiated texture when gelatinized and dispersed in an aqueous composition. For example, gelatinized unmodified aewx corn starch can provide substantial viscosity to aqueous dispersions, which is uncommon. Other waxy starches, in contrast, provide limited viscosity when gelatinized. Instead, commonly, waxy starches are modified, such as by inhibition (thermal inhibition or crosslinking), which maintains the starch's granular integrity when it is heated in water-i.e it inhibits gelatinization. As anther example, gelatinized unmodified aewx corn starch provides reversible firmness or gelling to aqueous compositions. In other words, the gels can be broken either with shear when the unmodified aewx corn starch is used in low amounts in a composition or thermally when used in high amount. This reversibility is unusual among native starches and is more commonly obtained using chemical modifications like oxidation. Accordingly, in any embodiment, this specification describes an unmodified aewx corn starch that is a pregelatinized unmodified aewx corn starch.

In at least some embodiments a pregelatinized unmodified aewx waxy starch is made in a drum drying process is drum dried. Drum drying starch involves cooking a thin film of starch dispersed in aqueous solution (typically water) on a rotating drum. The starch is in an amount from 30% to 40% by weight of the dispersion or the water is in an amount greater than about 50% (wt %) or greater than about 60% (wt. %), or from about 60% to 70% of the native aewx corn starch. The water is in amount so that the starch is in a flowable dispersion that can be deposited on the drum. The water is amount is limited, however, to an amount that can economically be evaporate during drying process. Drum driers are heated to evaporate moisture but run at a range of temperatures, for example between 50° and 150° C. The drum rotates at a fix rate although different rotational rates are possible, for example at from 15 to 30 RPM. As the starch is dried and cooked on the drum it is scraped off and then ground or sieved to obtain a desired particle size. Drum drying is a useful means for pregelatinizing native unmodified aewx corn starch because, in addition to heat, it provides shear to the starch. The combination of heat and shear aids in breaking down the starch granule so the that the pregelatinized unmodified aewx starch easily disperses in aqueous composition.

Unmodified aewx corn starch may be provided alone or in combination with other ingredients. In a combination, unmodified aewx corn starch may be provided as a component in a texturizing system or an ingredient in a larger composition. In any embodiment, this specification discloses a texturizer or a composition comprising an unmodified corn starch and a second edible ingredient.

In any embodiment, as an ingredient in a composition or a texturizer unmodified aewx corn starch is used in an amount of at least 0.1% (wt. % of the composition), or from about 0.1% to about 99%, or from about 0.1% to about 90%, or to about 80%, or to about 70%, or to about 60% or to about 50%, or to about 40%, or to about 30%, or to about 20%, or to about 10%. In some preferred embodiments of a composition or texturizer the unmodified aewx corn starch is in an amount from about 0.1%, or from about 1%, or from about 1.5%, or from about 2% to about 5%.

Other embodiments of compositions and texturizers comprising an unmodified aewx corn starch follow. In some embodiments a second ingredient is a second starch, which is different than the unmodified aewx corn starch. Useful second starches include but are not limited to corn starch, waxy corn starch, rice starch, waxy rice starch, tapioca starch, waxy tapioca starch, potato starch, waxy potato starch, pea starch, legume starch and mixtures thereof. Such second starches may be pure starches or may be part of a flour, meal, or similar material. For example rice flours, waxy rice flours, tapioca flour, and waxy tapioca flours comprise starch and may be used as the second starch. Second starches may be modified starches. This includes chemically modifications like etherification, esterification, oxidation, acidic conversion, enzymatic conversion, and mixtures thereof. Preferred chemical modifications include hydropropylation, acetylation, crosslinking (with phosphate or acetylate) and mixtures thereof. Modified starches may also be physically modified instead of chemically modified. A preferred physical modification are include thermally modified starches, for thermally inhibited starches. In any embodiment describe in this specification unmodified aewx corn starch and a second starch are in a ratio (aewx starch to second starch) of from 1:10 to 1:1 or from 1:6 to 1:1 from 1:5 to 1:1 or from 1:4 to 1:1, or from 1:3 to 1:1, or from 1:2 to 1:1. With reference to the second starch alone, in some preferred embodiments, the second starch is a thermally inhibited or crosslinked starch used in an amount from about 1% to about 5% or from about 2% to about 4% (wt. % of the composition).

Illustrative embodiments where the second edible ingredient is an aqueous component now follow. Useful aqueous components include but are not limited to water, milk, juice, puree, syrup, acidic liquids like vinegar, alkaline liquids. Aqueous components can be in liquid, steam, or solid form. Aqueous components may be the continuous phase of an oil-in-water emulsion, be held in a gel, or may be present in the composition or texturize as a moisture content. Aqueous components can be used in an amount from about 10% or from about 20%, or from about 30%, or from about 40%, or from about 50%, or from about 60%, or from about 70%, or from about 80% to about 90%. Compositions or texturizes can be generally low moisture or generally high moisture. In some embodiments the aqueous component is in an amount from about 20% to about 50%, or to about 40%, or to about 30%. In other embodiments an aqueous component is in an amount from about 50% to about 90%, or to about 80%, or to about 70%, or about 60%.

In some embodiments the second ingredient is a protein. In some such embodiments, the protein may be from a non-animal source for example a potato protein or a legume protein. Illustrative legume proteins include but are not limited to proteins from pea, fava bean, chickpea, lentil, and mixtures thereof. In any embodiment described in this specification a protein in an amount from about 0.1% to about 25% wt. % of the composition or from about 0.1% to about 20%, or to about 15%, or to about 10%. In some embodiments the protein is in an amount from about 0.1% or from about 1% or from about 5% or from about 10% to about 20%. In some other embodiments the protein is in an amount from about 0.1% or from about 1% or from about 5% or from about 10% to about 25%.

Still other useful second ingredients or other ingredients useful in a composition or texturize follow.

In any embodiment, an edible composition as described in this specification further comprises a sweetener. Useful sweeteners include honey, allulose, tagatose, fructose, glycerol, sucrose, rebaudiosides (A, B, J, M, etc.), and glucosylated stevia glycosides, corn syrups including high fructose corn syrups. Sweeteners may be provided in solid, or powdered, or liquid, or syrup form.

In any embodiment, an edible composition as described in this specification further comprises a fiber. Useful fibers may include cellulosic fibers from any botanical source, resistant starches, soluble fibers such as polydextrose or short chain fructooligosacchardies.

In any embodiment, an edible composition as described in this specification further comprises a gum or gum-like material. Useful gums and gum like materials include gelling starches, gum Arabic, xanthan gum, tara gum, konjac, carrageenan, locust bean gum, gellan gum, guar gum, pectin, and modified celluloses like carboxymethyl cellulose, and mixtures thereof.

In any embodiment, an edible composition comprising a deamidated legume protein isolate described in this specification useful fats include oils including vegetable oils such as corn oil, olive oil, canola oil, sunflower oil, rapeseed oil, palm oil, coconut oil.

Useful fats (other than vegetable oils) included animal fats and dairy fats. Most preferably the fat is a diary fat or butter fat which may be provided like cow's milk or cow's milk cream of desired fat content.

Useful aqueous ingredients include water, milk (including non-fat milk), syrups, juices from fruits or vegetables, fruit or vegetable purees, or other carbohydrate containing liquids, or acidic liquids, or basic liquids.

In various embodiments described in this specification compositions made with unmodified aewx corn starch have a gel firmness of less than about 60 g, or less than about 50 g. In other embodiments the compositions have a gel strength greater than about 10 g or greater than about 15 g, or from 10 to 60 g, or from 10 to 50 g, or from 15 to 60 g, or from 15 to 50 g. Illustrative compositions include but are not limited to custards, fruit fillings, yogurts, puddings, sauces, gravies, plant base yogurt analogs, and dressings.

In some embodiments where the composition is a yogurt or an analog yogurt the corn starch is in amount from about 0.1% (wt. % of the yogurt), or from about 1% or from about 1.5% or from about 2% to about 5%. In some embodiments where the composition is a yogurt or yogurt analog the second ingredient is a thermally inhibited starch in an amount about 1% to about 5% or from about 2% to about 4% (wt. % of the composition).

The subject matter described in this specification can be better understood with reference to the following definitions and guidance for construing the terms in this specification.

Reference in this specification to an “aewx corn starch” means a starch from the endosperm of a corn seed obtained from a corn plant having a genotype comprising three copies of a recessive waxy gene (wx) and two copies of a recessive amylose extender gene (ae). Said another way, an aewx corn starch is obtained from a corn plant having a genotype of wxwxwxaeaeAE.

Reference in this specification to an “aqueous component” means a component comprising water regardless of its phase (solid, liquid, gaseous, etc.). Aqueous component may be the continuous phase of an oil-in-water emulsion or may be held within a gel. Aqueous components may be measured as a moisture content of the composition. Aqueous components may comprise other ingredients which are suspended, dispersed, dissolved, or otherwise mixed in the aqueous component. Aqueous components have various pH. Non-limiting examples of aqueous components are water (whether in liquid form, as steam, or as ice), milk, juice, puree, syrup, acidic liquids like vinegar, alkaline liquids, and similar ingredients.

“Degree of polymerization”: starch is a glucose-based polysaccharide. Within this specification, the degree of polymerization refers to the number of glycosides in a starch polysaccharide.

Various “drum drying” processes are known in the art any of them may be used to pregelatinize the disclose unmodified aewx corn starches. Generally drum drying process work by applying a thin film of a starch slurry to a rotating heated drum. The drum cooks the starch in the slurry, pregelatinizing it, and evaporates the moisture from the slurry. The pregelatinized, dried starch is scraped off the drum, providing the end-product a flake-like, partially intact, partially sheared starch particle shape. Drum dried starches are commonly milled to obtain a specified particle size. With reference to commercial pregelatinized starches available from Ingredion Incorporated, coarser grinds may have a particle size distribution such that about 55% (by volume) of particles will settle on a 200-mesh (74-micron pore size) sieve and finer grinds may have a particle size distribution where at most about 1.0% of particles will settle on a 500-mesh (25-micron pore size) sieve.

“Gelatinized” or “gelatinization” of starch is a well-known term in the art. Its use in this specification is in line with the full understanding of the term. Without limiting the full meaning, gelatinization is a process where starch breaks down at the granular level so that starch polymers can disperse and dissolve in water or aqueous solution.

Within this specification “granular starch” refers to starch in its native granular form. The granular structure breaks down in the presence of heat and water, called gelatinization. Unmodified granular starch is starch in its native form that has not been modified, including by gelatinization. Within this specification unmodified granular starch is also called native starch.

Reference in this specification to “thermally inhibited” or “thermal inhibition” means a set of processes that alter a starches function so that it functions in aqueous solution like chemically crosslinked starch. Various methods are known for thermally inhibiting starch. Useful methods are described in WO 2020-139997 (which is incorporated herein in its entirety). Generally, thermally inhibited starch is made by soaking a native starch in a liquid containing a buffering agent, commonly the salt of an organic acid or base. The starch is soaked to allow the buffer to move into the starch granule. Buffered starch is then pH adjusted, depending on the buffer used, to have a pH in a range from about 4 to about 9.5. The buffered, pH adjusted starch is then dehydrated to have a moisture content less than about 2% (wt. % of the starch) and heated to a temperature from about 100° C. to about 200° C. for enough time to obtain a desired degree of thermal inhibition.

Reference in this specification to an “unmodified starch” includes gelatinized, granular, and partially gelatinized starch and mixtures thereof, but excludes starch that has been otherwise modified chemically, enzymatically, or physically.

The following tests were used to determine various properties of unmodified aewx corn starch and compositions made from the unmodified aewx corn starch.

“Debranching method: ” The following starch debranching method was used to calculated degree of polymerization of starch branch chains. Starch samples were added to a mixture containing 90% DMSO and 10% water. The mixture was heated in a boiling water bath under moderate stirring. The samples were then removed from the heat and continued to mix at room temperature overnight. Reagent alcohol was added to each sample to precipitate starch. The starch was then collected via centrifugation. The pellets from each starch sample were diluted in water and cooked in a boiling water bath to ensure full dispersion of the starch. Isoamylase was added to each sample for debranching under the specified pH and temperature conditions for the enzyme. Debranched enzyme samples were then filtered and loaded into the DIONEX ICS-3000 system for analysis.

A gradient elution profile consisting of sodium hydroxide and sodium nitrate was used for chain length separation. A degree of polymerization (“DP”) 1-7 solution was used as a peak retention time standard. Samples were integrated for peak area using Chromeleon software. Average branch chain length of starch samples was calculated from the molecular number average. Triplicate samples and duplicate injections for each sample were averaged.

“Monadic testing” as used in this specification has it usual meaning in the art: a type of survey research that introduces survey respondents to individual concepts in isolation. The specific process introduces samples to be tested individually. A control is evaluated, then the palate is cleansed, a test samples is evaluated, and panelists are asked to rate the relative difference between sample and control. The process is repeated for each test sample-i.e. the palate is cleansed, the control is reintroduced, the palate is cleansed, then the test sample is introduced and rated relative to the control.

“Retrogradation test: ” starch slurry was made and heated so that the starch was gelatinized. A 3:1 ratio of water: starch was added to stainless steel pans. The pans were sealed and added to a Perkin Elmer DSC programed to fully gelatinize the starch. Gelatinization peaks were integrated using ThemoCline DSC software which calculated onset, peak, and end gelatinization temperature, as well as enthalpy change. Gelatinized starch gels were stored in the sealed pans in a refrigerator for one week at 4° C. to induce retrogradation. The pans were then added to the DSC which ran the gelatinization program a second time to measure the enthalpy required to break the bonds formed during retrogradation. The average enthalpy measurement of the second scan was divided by the average enthalpy measurement for first scan (obtained during granule gelatinization) to compare retrogradation percentage or stability between samples.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology disclosed in this specification is further described by reference to the following aspects, which are provided for illustrative purposes and are not intended to limit the full scope of technology disclosed.

1. A pregelatinized unmodified aewx corn starch wherein optionally, the unmodified aewx corn starch is drum dried.

2. A drum dried unmodified aewx corn starch.

4. The unmodified aewx corn starch of claim 1 or 2 wherein the starch fully disperses into an aqueous solution wherein, optionally, full dispersion is determined by the dispersion test set forth in this specification.

4. The unmodified aewx corn starch of any one of claims 1 to 3 wherein the starch has a % retrogradation from about 45% to about 50%, or from about 46% to about 50% or from about 46% to about 49% as measured using the retrogradation test set forth in this specification.

5. The unmodified aewx corn starch of any one of claims 1 to 4 having an amylopectin fraction wherein a percent fraction of glycoside chains having a degree of polymerization (“DP”) between 25 and 36 of from about 17% to about 22%, or from about 18% to about 20%.

6. The unmodified awex corn starch of any one of claims 1 to 5 having an amylopectin fraction wherein the starch has a percent fraction of glycoside chains having DP greater than 37 of from about 14% to about 18% or from about 15% to about 17%.

7. The unmodified aewx corn starch of any one of claims 1 to 6 wherein, having an amylopectin fraction that comprises a distribution of glycoside chains having an average DP from about 23 to about 26, or from about 23 to about 25.

8. An unmodified pregelatinized corn starch wherein an amylopectin fraction of the starch has a percent fraction of glycoside chains having a degree of polymerization (“DP”) between 25 and 36 of from about 17% to about 22%, or from about 18% to about 20% wherein, optionally, the pregelatinized form starch is drum dried.

9. An unmodified drum dried corn starch wherein the starch has an amylopectin fraction having a percent fraction of glycoside chains having a degree of polymerization (“DP”) between 25 and 36 of from about 17% to about 22%, or from about 18% to about 20%.

10. An unmodified pregelatinized corn starch of claim wherein an amylopectin fraction of the starch comprises distribution of a glycoside chains having an average DP from about 23 to about 26, or from about 23 to about 25 wherein, optionally, the unmodified pregelatinized corn starch is a drum dried unmodified corn starch.

11. The unmodified corn starch of any one of claims 8 to 10 wherein the starch has an amylopectin fraction having a percent fraction of glycoside chains having DP greater than 37 of from about 14% to about 18% or from about 15% to about 17%.

12 The corn starch of any one of claims 8 to 11 wherein the starch disperses into an aqueous solution wherein, optionally, full dispersion is determined by the dispersion test set forth in this specification.

13. The corn starch of any one of claims 8 to 12 wherein the starch has a % retrogradation from about 45% to about 50%, or from about 46% to about 50% or from about 46% to about 49% as measured using the retrogradation test set forth in this specification.

14. The corn starch of any one of claims 8 to 13 wherein the corn starch is an aewx corn starch.

15. A composition comprising an unmodified corn starch and a second edible ingredient wherein unmodified corn starch is an unmodified aewx corn starch, comprises an amylopectin fraction of the unmodified having a percent fraction of glycoside chains having a degree of polymerization (“DP”) between 25 and 36 of from about 17% to about 22%, or from about 18% to about 20%, or a combination thereof.

16. The composition of claim 15 wherein the corn starch is as described in any one of claims 1 to 14.

17. The composition of claim 15 or 16 wherein the unmodified corn starch is used in an amount of at least 0.1% (wt. % of the composition) or from about 0.1% to about 99% or from about 0.1% to about 90%, or to about 80%, or to about 70%, or to about 60% or to about 50%, or to about 40%, or to about 30%, or to about 20%, or to about 10%, or from about 0.1%, or from about 1% or from about 1.5% or from about 2% to about 5%.

18. The composition of any one of claims 15 to 17 wherein the unmodified corn starch is a first starch, and the second edible ingredient is second starch, which is different than the first starch.

19. The composition any one of claims 15 to 18 wherein the second starch is a starch or flour selected from the group consisting of corn starch, waxy corn starch, rice starch, waxy rice starch, tapioca starch, waxy tapioca starch, potato starch, waxy potato starch, pea starch, legume starch.

20. The composition of any one of claims 15 to 19 wherein the second starch is a modified starch wherein, optionally, modification is selected from the group consisting of etherification, esterification, oxidation, acidic conversion, enzymatic conversion, and mixtures thereof wherein, optionally the modification is selected from the group consisting of hydropropylation, acetylation, crosslinking and mixtures thereof.

21. The composition of any one of claims 15 to 20 wherein the second starch is a thermally inhibited starch.

22. The composition of any one of claims 15 to 21 wherein the first starch and second starch are in a ratio of at least from 1:10 to 1:1 or from 1:6 to 1:1 from 1:5 to 1:1 or from 1:4 to 1:1, or from 1:3 to 1:1, or from 1:2 to 1:1.

23. The composition of any one of claims 15 to 22 wherein the second starch a thermally inhibited or crosslinked starch used in an amount from about 1% to about 5% or from about 2% to about 4% (wt. % of the composition).

24. The composition of any one of claims 15 to 23 wherein the second edible ingredient is an aqueous component wherein optionally, the aqueous component is selected from the group consisting of water (whether in liquid form, as steam, or as ice), milk, juice, puree, syrup, acidic liquids like vinegar, alkaline liquids.

25. The composition of any one of claims 15 to 24 wherein the second edible ingredient is an aqueous component present in an amount from about 10% or from about 20%, or from about 30%, or from about 40%, or from about 50%, or from about 60%, or from about 70%, or from about 80% to about 90%, or in an amount from about 20% to about 50%, or to about 40%, or to about 30%, or in an amount from about 50% to about 90%, or to about 80%, or to about 70%, or about 60%.

26. The composition any one of claims 15 to 26 wherein the second edible ingredient is a protein.

27. The composition of any one of claims 15 to 27 wherein the second edible ingredient is a protein from a non-animal source.

28. The composition of any one of claims 15 to 28 wherein the second edible ingredient is a plant protein wherein, optionally, the plant protein is a potato protein or a legume protein wherein, optionally the pant protein is legume protein selected from the group consisting of pea, fava bean, chickpea, lentil, and mixtures thereof.

29. The composition of any one of claims 15 to 29 wherein the second edible ingredient is a protein in an amount from about 0.1% to about 25% wt. % of the composition or from about 0.1% to about 20%, or to about 15%, or to about 10%, or from about 0.1% or from about 1% or from about 5% or from about 10% to about 20%, or from about 0.1% or from about 1% or from about 5% or from about 10% to about 25%.

30. The composition of any one of claims 15 to 30 wherein the composition has a gel firmness of less than about 60 g, or less than about 50 g.

31. The composition of any one of claims 15 to 31 wherein the composition has a firmness of greater than about 10 g or greater than about 15 g.

32. The composition of any one of claims 15 to 31 wherein the composition is selected from the group consisting of custards, fruit filling, yogurts, puddings, sauces, gravies, plant base yogurt analogs, and dressings.

33. The composition of any one of claims 15 to 32 wherein the composition is a yogurt or an analog yogurt wherein, optionally, the corn starch is in amount from about 0.1% (wt. % of the yogurt), or from about 1% or from about 1.5% or from about 2% to about 5%.

34. The composition of any one of claims 15 to 33 wherein the composition is a yogurt or an analog yogurt and wherein the second ingredient is a thermally inhibited starch in an amount about 1% to about 5% or from about 2% to about 4% (wt. % of the composition).

35. Use an unmodified corn starch as described in any one of claims 1 to 14 to modify the texture of an edible composition.

36. Use of a corn starch as described in claim 35 wherein the edible composition is in a fruit filling, yogurts, puddings, sauces, gravies, plant base yogurt analogs, and dressings.

37. A method of preparing a texturizer comprising: providing a native aewx corn starch mixing the native aewx corn starch with an aqueous composition to form a slurry, wherein, optionally the aqueous composition is in an amount greater than about 50% (wt %) or greater than about 60% (wt. %), or from about 60% to 70% of the native aewx corn starch heating the native aewx starch slurry to gelatinize the starch.

38. The method of claim 37 wherein the starch is gelatinized by drum drying the slurry wherein, optionally, the starch is heated on the drum drier at a temperate of from about 50° C. to about 150° C.; wherein, optionally, the drying drum is rotated at a rate from about 15 to about 30 rpm.

39. A method of making a food composition comprising mixing an unmodified aewx corn starch with a second edible ingredient to form a mixture.

40. The method of making a food composition further comprising: A. adding an aqueous composition to the mixture in an amount from about 10% or from about 20%, or from about 30%, or from about 40%, or from about 50%, or from about 60%, or from about 70%, or from about 80% to about 90%, or in an amount from about 20% to about 50%, or to about 40%, or to about 30%, or in an amount from about 50% to about 90%, or to about 80%, or to about 70%, or about 60%; and b. heating the mixture wherein, optionally, heating gelatinizes the unmodified aewx corn starch.

41. The method of claim 40 wherein the unmodified aewx corn starch is a gelatinized unmodified aewx corn starch, wherein, optionally further includes a limitation as recited in any one of claims 1 to 7.

42. The method of claim 40 or 41 wherein the second ingredient is as described in any foregoing claim.

43. A texturizer composition comprising an unmodified aewx corn starch wherein optionally, the unmodified aewx corn starch is described in claims 1 to 7.

44. A texturizing composition comprising an unmodified corn starch having an amylopectin fraction of the starch has a percent fraction of glycoside chains having a degree of polymerization (“DP”) between 25 and 36 of from about 17% to about 22%, or from about 18% to about 20% wherein, optionally, the corn starch is as described in any one of claims 8 to 14.

45. The texturizing agent of claim 43 or 44 further comprising a second starch wherein the texturizing agent of claims further comprising a second ingredient as described any foregoing claim.

The technology disclosed in this specification is further described by reference to the following examples, which are provided for illustrative purposes and are not intended to limit the full scope of technology disclosed.

### EXAMPLE 1—PHYSICAL ATTRIBUTES OF CORN STARCH

Attributes of amylose-containing corn starches and waxy corn starches are compared to the unmodified aewx corn starch are reported in the tables below.

Particle size: Starch particle size distribution was measured in powder form using a Malvern Mastersizer 3000 particle size analyzer. All samples were analyzed in triplicate. Table 1 reports the mode diameter for corn starch granules averaged over the three measurements. Waxy corn starch is common amylose free corn starch. Dent corn is common amylose containing corn starch. The unmodified aewx corn starch Samples 1 to 3 are from three separate milling campaigns from the same harvest of unmodified aewx corn kernels.

TABLE 1
Particles Sizes of Various Corn Starches
Corn starch particle size distribution (powder)

| Sample | Average mode (μm) |
|---|---|
| Waxy corn starch | 17.55 |
| Dent corn starch | 15.44 |
| unmodified aewx | 10.53 |
| corn starch Sample 1 | |
| unmodified aewx | 13.05 |
| corn starch Sample 2 | |
| unmodified aewx | 11.96 |
| corn starch Sample 3 | |

Particle size distribution indicates that the average granule diameter of unmodified aewx corn starch is smaller than waxy corn starch and dent corn starch.

Average branch chain length of starch samples was calculated from the molecular number average using ion exchange chromatography as the method of branch chain length separation.

“Debranching method:” The following starch debranching method was used to calculated degree of polymerization of starch branch chains. Starch samples were added to a mixture containing 90% DMSO and 10% water. The mixture was heated in a boiling water bath under moderate stirring. The samples were then removed from the heat and continued to mix at room temperature overnight. Reagent alcohol was added to each sample to precipitate starch. The starch was then collected via centrifugation. The pellets from each starch sample were diluted in water and cooked in a boiling water bath to ensure full dispersion of the starch. Isoamylase was added to each sample for debranching under the specified pH and temperature conditions for the enzyme. Debranched enzyme samples were then filtered and loaded into the DIONEX ICS-3000 system for analysis.

A gradient elution profile consisting of sodium hydroxide and sodium nitrate was used for chain length separation. A degree of polymerization (“DP”) 1-7 solution was used as a peak retention time standard. Samples were integrated for peak area using Chromeleon software. Average branch chain length of starch samples was calculated from the molecular number average. Triplicate samples and duplicate injections for each sample were averaged. Results are reported in Table 2.

TABLE 2
Branch Chain Distribution of Various Starch

| | Percent distribution | | | | | | | | | | | | | | |
|---|---|---|---|---|---|---|---|---|---|---|---|---|---|---|---|
| Sample | 6-12 | | | 13-24 | | | 25-36 | | | ≥37 | | | Average DP | | |
| Waxy corn | 19.5 | ± | 0.3 | 49.3 | ± | 1.3 | 18.4 | ± | 0.3 | 12.8 | ± | 1.0 | 22.2 | ± | 0.3 |
| starch | | | | | | | | | | | | | | | |
| unmodified | 16.5 | ± | 0.6 | 47.4 | ± | 0.6 | 19.6 | ± | 0.3 | 16.6 | ± | 1.0 | 24.1 | ± | 0.3 |
| aewx corn | | | | | | | | | | | | | | | |
| starch Sample 1 | | | | | | | | | | | | | | | |
| unmodified | 16.8 | ± | 0.8 | 46.3 | ± | 2.4 | 19.3 | ± | 0.4 | 17.6 | ± | 2.4 | 24.4 | ± | 1.0 |
| aewx corn | | | | | | | | | | | | | | | |
| starch Sample 2 | | | | | | | | | | | | | | | |
| unmodified | 15.8 | ± | 1.0 | 46.2 | ± | 1.8 | 20.0 | ± | 0.5 | 18.0 | ± | 2.2 | 24.7 | ± | 1.0 |
| aewx corn | | | | | | | | | | | | | | | |
| starch Sample 3 | | | | | | | | | | | | | | | |

The average DP of unmodified aewx corn starch samples is approximately two glucose units longer than waxy corn starch. Average DP and chain length distribution is very similar for all batches.

Gelatinization temperature was identified using differential scanning calorimetry (DSC). starch slurry was made and heated so that the starch was gelatinized. A 3:1 ratio of water: starch was added to stainless steel pans. The pans were sealed and added to a Perkin Elmer DSC programed to fully gelatinize the starch. Gelatinization peaks were integrated using ThemoCline DSC software which calculated onset, peak, and end gelatinization temperature, as well as enthalpy change.

Results are reported in Table 3. The unmodified aewx corn starch had a higher onset, peak, and end gelatinization temperature than waxy corn starch. The unmodified aewx corn starch had onset gelatinization about 2° C. higher than waxy corn starch. Without being bound by theory, the longer branch chain length of unmodified aewx corn starch (in comparison to waxy corn starch) likely contributes to the higher observed gelatinization temperature. All unmodified aewx corn starches isolated have similar onset, peak, and end gelatinization temperatures.

TABLE 3
Gelatinization Profile of Starch

| Sample | Onset (° C.) | | | Peak (° C.) | | | End (° C.) | | | ΔH (J/g) | | |
|---|---|---|---|---|---|---|---|---|---|---|---|---|
| Waxy corn starch | 65.1 | ± | 0.3 | 71.9 | ± | 0.2 | 78.7 | ± | 0.5 | 17.8 | ± | 0.3 |
| unmodified aewx | 67.0 | ± | 0.7 | 74.3 | ± | 0.5 | 82.7 | ± | 0.5 | 17.4 | ± | 0.4 |
| corn starch Sample 1 | | | | | | | | | | | | |
| unmodified aewx | 66.4 | ± | 0.2 | 73.4 | ± | 0.0 | 82.5 | ± | 0.1 | 16.7 | ± | 0.2 |
| corn starch Sample 2 | | | | | | | | | | | | |
| unmodified aewx | 67.2 | ± | 0.2 | 74.1 | ± | 0.2 | 81.0 | ± | 0.1 | 17.0 | ± | 1.3 |
| corn starch Sample 3 | | | | | | | | | | | | |

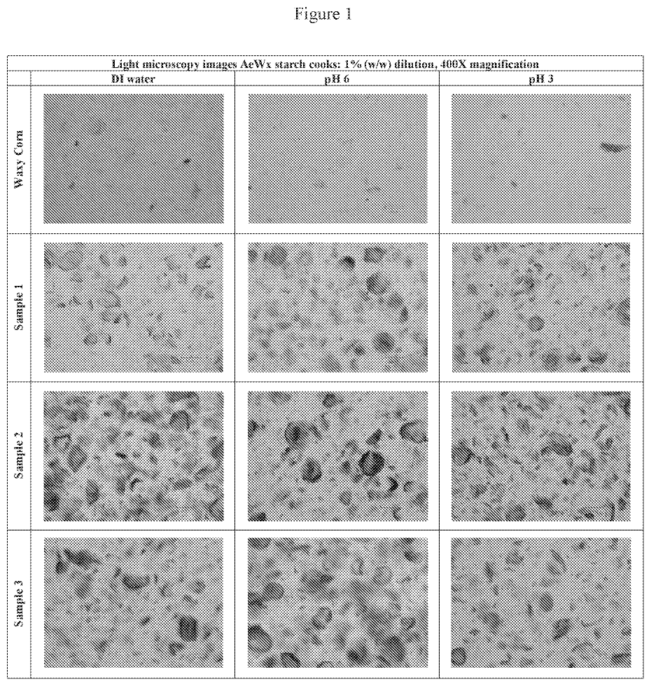

Microscopy of starch cooks: samples of gelatinized starch were collected and were mixed with 80 μL of 0.1N iodine solution for staining. One to three drops of solution (starch, water and iodine) were pipetted onto a glass slide before mounting on the light microscope (Nikon Eclipse 80i) stage at 400× magnification. Images of the sample were taken at three different regions on the slide. Images are provided in FIG. 1. Images of unmodified aewx corn starch pastes show swollen, intact granules, and large granule fragments. Waxy corn starch, in contrast, showed small granule fragments. Higher gelatinization temperature (Table 3) coupled with granule integrity after cooking (FIG. 1) indicates that native unmodified aewx corn starch requires more harsh processing to fragment during cooking.

Retrogradation stability was tested by storing the sealed pans from gelatinization measurement in the refrigerator for one week at 4° C. to induce retrogradation. The pans were then added to the DSC which ran the gelatinization program a second time to measure the enthalpy required to break the bonds formed during retrogradation. The average enthalpy measurement of the second scan was divided by the average enthalpy measurement for first scan (obtained during granule gelatinization) to compare retrogradation percentage or stability between samples.

Results from retrogradation stability testing are reported in Table 4. The unmodified aewx corn starch had a lower retrogradation stability than waxy corn starches.

TABLE 4
Retrogradation Stability of Waxy Corn Starch

| | Retrogradation |
|---|---|
| Sample | (%) |
| Waxy corn starch | 42.9 ± 1.0 |
| unmodified aewx | 44.2 ± 1.2 |
| corn starch Sample 1 | |
| unmodified aewx | 47.9 ± 0.8 |
| corn starch Sample 2 | |
| unmodified aewx | 48.1 ± 0.4 |
| corn starch Sample 3 | |

Unmodified aewx corn starch has more retrogradation than waxy corn starch. This shows that unmodified aewx corn starch tends to form firmer compositions over time, which is a trait that can be used to provide differentiated texture compared to starches from other sources.

### EXAMPLE 2A—RHEOLOGICAL EVALUATION OF A MODEL YOGURT FORMULATIONS

Yogurts were made and evaluated for gel firmness and viscosity. Formulas for the yogurt systems are presented in Table 5. The formulas provide two relevant comparisons. They compare the effect of different gelling agents (gelatin, modified potato starch, and unmodified aewx corn starch) to each other and to a system using no gelling agent. They also compare the effect on the yogurt of varying the amount of unmodified aewx corn starch used.

TABLE 5
Yogurt Formulations

| Ingredient (wt. %) | Sample 1 | Sample 2 | Sample 3 | Sample 4 | Sample 5 | Sample 6 | Sample 7 | Sample 8 |
|---|---|---|---|---|---|---|---|---|
| Skim milk | 93.3 | 93.05 | 93.05 | 92.52 | 91.97 | 93.07 | 92.52 | 93.05 |
| Heavy cream, 40% fat | 2.38 | 2.38 | 2.38 | 2.38 | 2.38 | 2.38 | 2.38 | 2.38 |
| Thermally inhibited | 3 | 3.5 | 3 | 3 | 3 | 2.5 | 2.5 | 3 |
| waxy corn | | | | | | | | |
| Unmodified aewx | — | — | 0.5 | 1 | 1.5 | 1 | 1.5 | — |
| corn starch | | | | | | | | |
| Gelling potato starch\hat{ } | — | — | — | — | — | — | — | 0.5 |
| NFDM low hcat* | 1 | 1.05 | 1.05 | 1.08 | 1.13 | 1.03 | 1.08 | 1.05 |
| Gelatin | 0.3 | — | — | — | — | — | — | — |
| Culture | 0.02 | 0.02 | 0.02 | 0.02 | 0.02 | 0.02 | 0.02 | 0.02 |
| TOTAL | 100.00 | 100.00 | 100.00 | 100.00 | 100.00 | 100.00 | 100.00 | 100.00 |

*NFDM low-heat refers to low-heat nonfat dry milk powder, which is a common commercial product that is used to fortify with protein things like ice cream and other aqueous systems where solubility of the milk protein is important. Low-heat NFDM provides a more soluble dried milk powder than a high-heat NFDM powder. Low-heat NFDM powders are dried to remove water from pasteurized skim milk using a temperature of no more than 160° F. (about 71° C.) for 2 minutes. In contrast, a high heat NFDM powder is commonly heated at about 190° F. (about 88° C.) for about 30 minutes.
\hat{ }Etenia ™ 457 potato starch (available from Avebe).

Yogurts were made as follows. The process formed a dry pre-blend of thermally inhibited starch, gelling agent, and maltodextrin. The dry pre-blend was added to the skim milk and mixed using a high shear mixer, like those available from Likwifier. The dry mix and skim milk were mixed for 15minutes at approximately 500 rpm. The mixture was then transferred to a holding tank and mixed under medium agitation for 10 minutes. Heavy cream was then added, and the complete mixture was mixed for 3-5 minutes. The complete mixture was then transferred to Microthermics HVHW HTST processing equipment to make the yogurt by preheating to 65° C. then homogenizing at a first stage pressure of 30 bar, and a second stage pressure of 150 bar. The homogenized mix was then pasteurized at about 98° C., for 6 minutes. Pasteurized mix was cooled to mix to about 43° C. The mix was then fermented by adding culture. Fermentation was stopped by cooling once yogurt pH dropped to 4.6 mixtures. Mix was cooled to about 12° C. using a Microthermics glycol chiller tube with built in 60 mesh screen. Yogurt packaged into 4 oz. cups and stored at refrigerated temperatures of about 4° C.

Samples were measured for firmness, and viscosity. Gel firmness was measured using TAXT2 Punch test. Machine was calibrated to use yogurt punch test technique and 3.2″×1″ diameter acrylic probe was press into yogurt at 0.2 mm/s to a depth of 15 mm, at 15 mm, hold for 200 seconds, and release from yogurt at 2 mm/s rate. Peak force experienced during compression is used as gel firmness. For gel firmness testing, samples were stored at 4° C. and samples measured at 1-, 7-, 21-, and 49-days. Measurements were taken soon after samples were removed from refrigeration so that samples were measured at about 4° C.

Yogurts were measured for viscosity using Brookfield viscometer fitted with Helipath using a T Bar-94, and with the viscometer set to savory yogurt method. (For convenience, this specification refers to viscosities measured by the Brookfield viscometer as a “Brookfield viscosity.”) Helipath moves the T-Bar probe in a helical path to minimize the effect of shear on the viscosity measurements. Yogurts were also measured for sheared viscosity using a parallel plate rheometer such as those available from Anton Paar. (For convenience sheared viscosity obtained using a parallel plate rheometer is called an “Anton Paar viscosity” in this specification.) Shear rate was 10 1/s and was selected to approximate the shear applied during eating. For Brookfield and Anton Paar viscosity tests, samples were stored at 4° C. and measured after 1-, 7-, 21-, and 49-days' storage. Measurements were taken soon after samples were removed from refrigeration so that samples were measured at about 4° C.

### EXAMPLE 2B—RHEOLOGICAL EVALUATION OF VARIOUS STARCH IN YOGURT FORMULATIONS

Tables 6, 7, and 8 report rheological results obtained from yogurts using different gelling agents (Samples 1, 2, 3 and 8). The results show that a yogurt made with a starch system having unmodified aewx corn starch (0.5% wt. %) and thermally inhibited waxy corn starch (3%) better matches the gel firmness and Brookfield and Anton Paar viscosities of a yogurt made with gelatin than did a yogurt made with a gelling potato starch.

Table 6 reports the gel firmness of yogurts made with different gelling agents. Measurements were taken after 1-, 7-, 21- and 49-day's storage at 4° C. Results are reported in grams force (g).

TABLE 6
Gel firmness of Yogurt using Different Gelling Agents

| | Day 1 | Gel | Gel | Gel |
|---|---|---|---|---|
| | Gel | Day 7 | Day 21 | Day 49 |
| | firmness | firmness | firmness | firmness |
| Sample | (g) | (g) | (g) | (g) |
| Sample 1 | 21.1 | 22.5 | 24.0 | 24.2 |
| Gelatin | | | | |
| Sample 2 | 20.4 | 21.7 | 23.7 | 23.8 |
| No gelling agent | | | | |
| Sample 3 | 17.8 | 20.0 | 21.1 | 24.7 |
| 0.5 wt. % unmodified | | | | |
| aewx corn starch | | | | |
| Sample 8 | 21.4 | 22.4 | 27.1 | 33.3 |
| 0.5% gelling potato | | | | |
| starch | | | | |

Sample 3 made with unmodified aewx corn starch in an amount of 0.5% (wt. %) of the yogurt has slightly less gel firmness than other samples at day 1 but builds gel firmness so that by day 7 it has comparable gel firmness to the other samples. Sample 3 also has comparable gel firmness at days 21 and 49. Sample 8, in contrast, continued becoming firmer and was much firmer than other samples at day 21 and day 49.

Table 7 reports the Brookfield Viscosity of yogurt samples made with different gelling agents. Measurements were taken after 7-, 14-, 21-, and 49-days' storage at 4° C. Results are reported in millipascal seconds.

TABLE 7
Brookfield Viscosity of Yogurt with Different Gelling Agents

| | Day 1 | Day 7 | Day 21 | Day 49 |
|---|---|---|---|---|
| | Viscosity | Viscosity | Viscosity | Viscosity |
| Samples | (mPa*s) | (mPa*s) | (mPa*s) | (mPa*s) |
| Sample 1 | 14,600 | 15,467 | 17,500 | 10,400 |
| Gelatin | | | | |
| Sample 2 | 13,900 | 16,067 | 16,400 | 10,333 |
| No gelling agent | | | | |
| Sample 3 | 10,133 | 13,467 | 15,600 | 10,267 |
| 0.5 wt. % unmodified | | | | |
| aewx corn starch | | | | |
| Sample 8 | 15,467 | 17,267 | 19,933 | 16,867 |
| 0.5% gelling potato | | | | |
| starch | | | | |

Samples 1, 2, 3, and 8 all had comparable Brookfield viscosity at 7-, 14-, 21-, and 49-days' storage. All sample had increasing viscosity through 21-days' storage. Viscosity broke down thereafter. Generally, Sample 8, made with 0.5% (wt. %) gelling potato starch had slightly higher viscosity than all other samples. But the difference in viscosity between Sample 8 and Samples 1 or 2 increased over time. Generally, Sample 3, made with 0.5% (wt. %) unmodified aewx corn starch had had the lowest viscosity compared to other samples, but the difference in viscosity between Sample 3 and Samples 1 or 2 decreased over time.

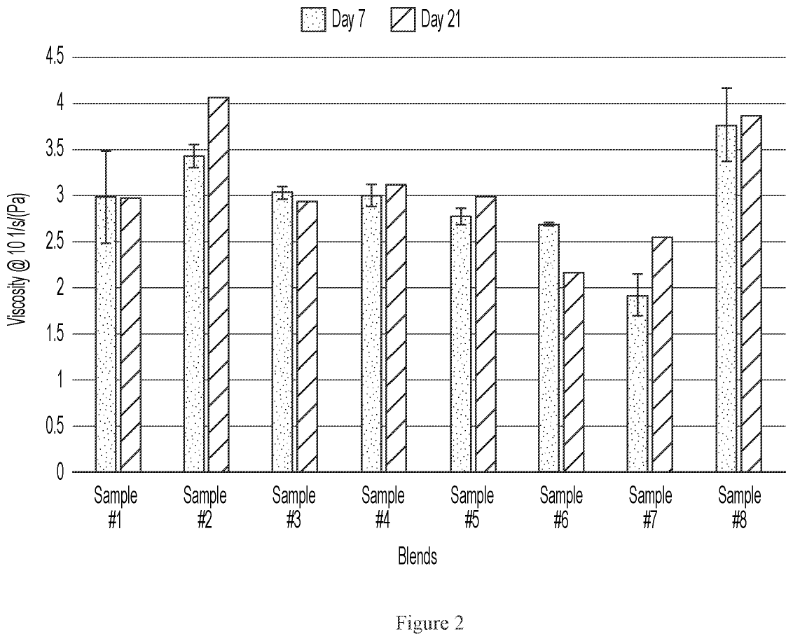

Anton Paar viscosity of yogurts made with different gelling agents was measured at shear rate of 10 1/s to mimic the shear applied during eating. Measurements were taken after 7-and 21-days' storage at 4° C. results are reported in Table 8 and FIG. 2. Results are reported in pascals.

TABLE 8
Anton Paar Viscosity of Yogurt with Different Gelling Agents

| | Day 7 Viscosity @ | Day 21 Viscosity @ |
|---|---|---|
| Sample | 10 1/s/(Pa) | 10 1/s (Pa) |
| Sample 1 | 3.0 | 3.0 |
| Gelatin | | |
| Sample 2 | 3.5 | 4.1 |
| No gelling agent | | |
| Sample 3 | 3.1 | 2.9 |
| 0.5 wt. % unmodified | | |
| aewx corn starch | | |
| Sample 8 | 3.8 | 3.9 |
| 0.5 wt. % gelling | | |
| potato starch | | |

All samples showed some shear thinning, having lower viscosity than measured by Brookfield viscosity analyzer. Sample 3 (0.5% unmodified aewx corns starch) has closer Anton Paar viscosity (10 1/s) to Sample 1 (gelatin) than Sample 2 (not gelling agent) or 8 (gelling potato starch).

### EXAMPLE 2C-RHEOLOGICAL EVALUATION OF VARIOUS AMOUNTS OF UNMODIFIED AEWX CORN STARCH IN YOGURT FORMULATIONS

Tables 9, 10 and 11 report rheological results obtain from yogurts made with different amounts of unmodified aewx corn starch and different ratios of unmodified aewx corn starch to thermally inhibited waxy corn starch.

Table 9 reports the gel firmness of yogurts made with different amounts of unmodified aewx starch. Measurements were taken after 1-, 7-, 21- and 49-day's storage at 4° C. Results are reported in grams force (g).

TABLE 9
Gel firmness of Yogurt Using Different
Amounts of Unmodified aewx Corn Starch

| | Day 1 | Gel | Gel | Gel |
|---|---|---|---|---|
| | Gel | Day 7 | Day 21 | Day 49 |
| | firmness | firmness | firmness | firmness |
| Samples | (g) | (g) | (g) | (g) |
| Sample 3 | 17.8 | 20.0 | 21.1 | 24.7 |
| 3 wt. % TI wx corn | | | | |
| starch to 0.5 wt. % | | | | |
| unmodified aewx corn | | | | |
| starch | | | | |
| Sample 4 | 16.9 | 22.2 | 29.6 | 38.1 |
| 3 wt. % TI wx corn | | | | |
| starch to 1 wt. % | | | | |
| unmodified aewx corn | | | | |
| starch | | | | |
| Sample 5 | 20.1 | 22.9 | 38.0 | 58.1 |
| 3 wt. % TI wx corn | | | | |
| starch to 1.5 wt. % | | | | |
| unmodified aewx corn | | | | |
| starch | | | | |
| Sample 6 | 16.9 | 19.8 | 26.2 | 34.2 |
| 2.5 wt. % TI wx corn | | | | |
| starch to 1 wt. % | | | | |
| unmodified aewx corn | | | | |
| starch | | | | |
| Sample 7 | 17.8 | 25.4 | 31.5 | 49.6 |
| 2.5 wt % TI wx corn | | | | |
| starch to 1.5 wt. % | | | | |
| unmodified aewx corn | | | | |
| starch | | | | |

Gel firmness increases over time for all samples and using more total starch were firmer (e.g Samples 3 to 5). Also, unmodified aewx corn starch contributes more to gel firmness than amount of thermally inhibited waxy corn starch. For example, Sample 4 and Sample 7 have equal total starch, but Sample 7 using more unmodified aewx corn starch is firmer. The firmness of Sample 4 is more like Sample 6 which uses less total starch, but equal unmodified aewx corn starch.

Table 10 reports the Brookfield viscosity of yogurt samples made with different amounts of unmodified aewx corn starch. Measurements were taken after 7-, 14-, 21-, and 49-days' storage at 4° C. Results are reported in millipascal seconds.

TABLE 10
Brookfield Viscosity of Yogurt with Different
Amounts of Unmodified aewx corn starch

| | Day 1 | Day 7 | Day 21 | Day 49 |
|---|---|---|---|---|
| | Viscosity | Viscosity | Viscosity | Viscosity |
| Samples | (mPa*s) | (mPa*s) | (mPa*s) | (mPa*s) |
| Sample 3 | 10,133 | 13,467 | 15,600 | 10,267 |
| 3 wt. % TI wx corn | | | | |
| starch to 0.5 wt. % | | | | |
| unmodified aewx corn | | | | |
| starch | | | | |
| Sample 4 | 8,267 | 13,667 | 18,733 | 18,000 |
| 3 wt. % TI wx corn | | | | |
| starch to 1 wt. % | | | | |
| unmodified aewx corn | | | | |
| starch | | | | |
| Sample 5 | 10,467 | 16,867 | 25,600 | 24,600 |
| 3 wt. % TI wx corn | | | | |
| starch to 1.5 wt. % | | | | |
| unmodified aewx corn | | | | |
| starch | | | | |
| Sample 6 | 9,467 | 12,400 | 18,133 | 15,933 |
| 2.5 wt. % TI wx corn | | | | |
| starch to 1 wt. % | | | | |
| unmodified aewx corn | | | | |
| starch | | | | |
| Sample 7 | 9,267 | 14,067 | 22,000 | 22,000 |
| 2.5 wt % TI wx corn | | | | |
| starch to 1.5 wt. % | | | | |
| unmodified aewx corn | | | | |
| starch | | | | |

Brookfield viscosity for all samples follows a similar trend to gel firmness. Brookfield viscosity increases with increasing total starch. (Compare e.g. Samples 3, 4, and 5) The amount of unmodified aewx corn starch contributes more to the viscosity than the amount of thermally inhibited waxy corn. For example, Sample 4 and Sample 6 are made with equal unmodified aewx corn starch, but sample 6 uses the less total starch. Sample 4 and 7 have the same total starch, but Sample 7 is made with more unmodified aewx corn starch. Sample 4 has a Brookfield viscosity profile closer to Sample 6 than Sample 7, and Sample 7 is generally more viscous than Sample 4.

Anton Paar viscosity of yogurts made with different amounts of unmodified aewx corn starch was measured at shear rate of 10 1/s to mimic the shear applied during eating. Measurements were taken after 7- and 21-days' storage at 4° C. Results are reported in Table 11 and FIG. 2. Results reported in pascals.

TABLE 11
Anton Paar Viscosity of Yogurt with Different
Amounts of Unmodified aewx Corn Starch

| | Viscosity @ | Viscosity @ |
|---|---|---|
| | 10 1/s/(Pa) after | 10 1/s (Pa) after |
| Sample | 7 days | 21 days |
| Sample 3 | 3.1 | 2.9 |
| 3 wt. % TI wx corn starch to 0.5 | | |
| wt. % unmodified aewx corn starch | | |
| Sample 4 | 3.1 | 3.1 |
| 3 wt. % TI wx corn starch to 1 | | |
| wt. % unmodified aewx corn starch | | |
| Sample 5 | 2.8 | 3.0 |
| 3 wt. % TI wx corn starch to 1.5 | | |
| wt. % unmodified aewx corn starch | | |
| Sample 6 | 2.7 | 2.2 |
| 2.5 wt. % TI wx corn starch to 1 | | |
| wt. % unmodified aewx corn starch | | |
| Sample 7 | 2.1 | 2.5 |
| 2.5 wt % TI wx corn starch to 1.5 | | |
| wt. % unmodified aewx corn starch | | |

Anton Paar viscosity (a shear viscosity) depends more on the amount of thermally inhibited waxy corn starch used. For example, Samples 3 and 5 made with different amounts of unmodified aewx corn starch have similar viscosity. Samples 6 and 7 are made with less thermally inhibited waxy corn starch than Sample 3 or 5 and had lower Anton Paar viscosity.

Summarizing the rheology tests at least three observations can be made. Unmodified aewx corn starch tends to retrograde and form firmer compositions over time. At their firmest the, compositions described in this specification have firmness no more than about 60 g and have a viscosity that thins with shear. Unmodified aewx corn starch can be mixed with other starches to adjust a composition's rheology and to mimic the texture provided by other gelling agents.

### EXAMPLE 3—SENSORY EVALUATION

Yogurt Samples 1 to 8 were evaluated for sensory differences, but for clarity of presentation this Example reports results from Samples 1, 3 and 8 (as described in Example 2). Samples were formally evaluated for sensory properties by a highly trained panel of 15 people. For reference, Sample 1 is a yogurt made with gelatin, Sample 3 was made with 0.5% (wt. %) unmodified aewx corn starch, and Sample 8 (wt. %) was made with gelling potato starch. Samples were evaluated for cream texture, particles in mouth, and evenness of mouthcoating. Creamy Texture was defined as the extent to which a food sample spreads smoothly, with a lack of shear, and clears easily from mouth surfaces. Particles in Mouth was defined as the perceived and number of particles perceived in the mouth, ranging from very fine to coarse, in a food sample on the mouth surfaces during manipulation. Evenness of Mouthcoating was defined as the extent to which a food sample evenly spreads over the mouth surfaces during manipulation.

Samples were evaluated on scale range from-5 to 5 relative to Sample 1, which was set to 0. Ratings represent magnitude of perceived difference between a Sample and Sample 1. Attributes rated with a negative number were less noticeable than the Sample 1. Attributes rated with a positive number were more noticeable than Sample 1.

Testing was monadic using a randomized balanced design. There was a five-minute delay between the introduction of a new sample-i.e. control is introduced palate is cleansed, first sample is introduced, samples are compared, palate is cleansed, five-minute delay then the process is reiterated. Palate cleansers were spring water and unsalted saltine crackers. Data was entered into Compusense Cloud and analyzed using XLSTAT (v2020). Samples were evaluated after 21-days' storage at 4° C. Samples were removed from refrigerator immediately before evaluation began so that samples were tested at about 4° C. Samples were provided in 4 oz (about 118 mL) transparent plastic cups with lids.

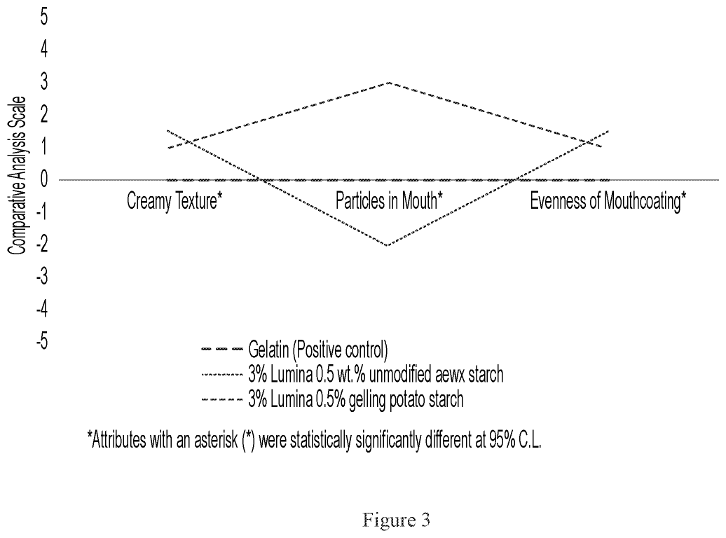

Results are presented in FIG. 3. Summarizing the results from Examples 2 and 3, at least two observations can be made. Yogurts made with 0.5% unmodified aewx corn starch better matched the firmness, Brookfield viscosity, and Anton Paar viscosity of yogurts made with gelatin than did yogurts made with gelling potato starch. Yogurts made with 0.5% (wt) % unmodified aewx corn starch were rated to have lower particles in mouth, higher evenness of mouth coating and higher creamy texture than gelatin (and lower particles in mouth than 0.5% (wt. %) gelling potato starch).

### EXAMPLE 4—PLANT BASED YOGURT ANALOG

The differentiated textures obtainable by using an unmodified aewx corn are expected to be useful in diary analog compositions, such as yogurt analogs. An illustrative formula for a plant-based yogurt analog is provided in Table 12.

TABLE 12
Module Formula for Plant-based Yogurt Analog

| Ingredient | % (w/w) |
|---|---|
| Sunflower oil | 3.33 |
| Low amylose tapioca | 0.50 |
| flour | |
| Water | 79.58 |
| Sugar | 4.00 |
| Unmodified aewx corn | 0.09 |
| starch | |
| Pea protein isolate | 12.50 |
| Totals | 100 |

Dairy yogurt analogs can be made using common yogurt processing such as described in the example of this specification. Alternately, the process can be modified to allow the fermented material to cool before homogenization to form the final yogurt analog product. An illustrative method follows. A base material comprising all ingredients said in Table 12 is mixed and then is homogenized to from a stabile suspension of solids. he homogenized base material is then pasteurized and is then fermented. The fermented material may be cooled 10 and 15° C. before further processing. Further process includes shearing the fermented material, commonly during a pumping process using, for example, a rotary vane pump. Commonly, the pumping process pushes the sheared, fermented base material through a smoothing step, which often uses of a fine-mesh screen, but may include shearing to break lumps. The final composition is then put in into containers for storage.

1. A pregelatinized unmodified aewx corn starch.

2. The pregelatinized unmodified aewx corn starch of claim 1 wherein the pregelatinized unmodified aewx corn starch is drum dried.

3. The pregelatinized unmodified aewx corn starch of claim 1 wherein the starch fully disperses into an aqueous solution.

4. (canceled)

5. The pregelatinized unmodified aewx corn starch of claim 1 having an amylopectin fraction wherein a percent fraction of glycoside chains having a degree of polymerization (“DP”) between 25 and 36 of from about 17% to about 22%.

6. The pregelatinized unmodified awex corn starch of claim 1 having an amylopectin fraction wherein the starch has a percent fraction of glycoside chains having DP greater than 37 of from about 14% to about 18%.

7. The pregelatinized unmodified aewx corn starch of claim 1 wherein, having an amylopectin fraction that comprises a distribution of glycoside chains having an average DP from about 23 to about 26.

8. An unmodified pregelatinized corn starch of claim 1 wherein an amylopectin fraction of the starch has a percent fraction of glycoside chains having a degree of polymerization (“DP”) between 25 and 36 of from about 17% to about 22%.

9-14. (canceled)

15. A composition comprising:
a) a first starch that is an unmodified aewx corn starch used in an amount of at least 0.1% (wt. % of the composition) and
b) a second starch selected from the group consisting of corn starch that is not an aewx corn starch, waxy corn starch that is not an aewx corn starch, rice starch, waxy rice starch, tapioca starch, waxy tapioca starch, potato starch, waxy potato starch, pea starch, legume starch
wherein the first starch and second starch are in a weight ratio of at least from 1:10 to 1:1.

16-19. (canceled)

20. The composition of claim 15 wherein the second starch is a modified starch.

21. The composition of claim 15 wherein the second starch is a thermally inhibited starch.

22. (canceled)

23. The composition of claim 15 wherein the second starch is a thermally inhibited or crosslinked starch used in an amount from about 1% to about 5% (wt. % of the composition).

24. The composition of claim 15 further comprising an aqueous component in an amount from about 10% to about 90% (wt. % of the composition).

25. (canceled)

26. The composition of claim 15 further comprising a protein in an amount from about 0.1% to about 25% (wt. % of the composition).

27. (canceled)

28. The composition of claim 15 further comprising a plant protein in an amount from about 0.1% to about 25% (wt. % of the composition)
wherein the plant protein is selected from the group consisting of pea, fava bean, chickpea, lentil, and mixtures thereof.

29-31. (canceled)

32. The composition of claim 15 wherein the composition is selected from the group consisting of custards, fruit filling, yogurts, puddings, sauces, gravies, plant base yogurt analogs, and dressings.

33. The composition of claim 15 wherein the composition is a yogurt or an analog yogurt and wherein the unmodified aewx corn starch is in amount from about 0.1% (wt. % of the yogurt) to about 5%.

34. The composition of claim 15 wherein the composition is a yogurt or an analog yogurt and wherein the second starch is a thermally inhibited starch in an amount about 1% to about 5% (wt. % of the composition).

35-38. (canceled)

39. A method of making a food composition comprising:
mixing
a) a first starch that is an unmodified aewx corn starch, the unmodified aewx corn starch being used in an amount of at least 0.1% of the composition
b) a second starch selected from the group consisting of corn starch that is not an aewx corn starch, waxy corn starch that is not an aewx corn starch, rice starch, waxy rice starch, tapioca starch, waxy tapioca starch, potato starch, waxy potato starch, pea starch, legume starch wherein the first starch and second starch are in a ratio of at least from 1:10 to 1:1; and
c) an aqueous composition to the mixture in an amount from about 10% to about 90%,
to form a mixture and
heating the mixture.

40. (canceled)

41. The method of claim 39 wherein the unmodified aewx corn starch is a gelatinized unmodified aewx corn starch,

42-45. (canceled)

46. The method of claim 39 wherein the heating gelatinizes the unmodified aewx corn starch.
